(19) United States
(12) Patent Application Publication
(10) Pub. No.: US 2026/0302172 A1
(43) Pub. Date: Oct. 1, 2026

(54) ELECTRODE AND MANUFACTURING METHOD OF ELECTRODE

(71) Applicant: TOYOTA JIDOSHA KABUSHIKI KAISHA, Toyota-shi (JP)

(72) Inventors: Hirokazu TAKEUCHI, Toyota-shi (JP); Yusuke KINTSU, Toyota-shi (JP); Satoru CHIMURA, Toyota-shi (JP); Takahiko NAKANO, Nagoya-shi (JP)

(73) Assignee: TOYOTA JIDOSHA KABUSHIKI KAISHA, Toyota-shi (JP)

(21) Appl. No.: 19/454,644

(22) Filed: Jan. 21, 2026

(30) Foreign Application Priority Data
Mar. 27, 2025 (JP) 2025-053635

(51) Int. Cl. H01M 4/139; H01M 4/02

(52) U.S. Cl. CPC H01M 4/139; H01M 2004/021

(57) ABSTRACT

An electrode includes: a current collector; and an electrode layer provided on the current collector, in which the electrode layer includes a first electrode layer that is at least a portion of an edge portion of the electrode layer, and a second electrode layer that is a portion of the electrode layer other than the first electrode layer, and a peel strength of the first electrode layer with respect to the current collector is lower than a peel strength of the second electrode layer with respect to the current collector.

### CROSS-REFERENCE TO RELATED APPLICATION

This application claims priority to Japanese Patent Application No. 2025-053635 filed on Mar. 27, 2025. The disclosure of the above-identified application, including the specification, drawings, and claims, is incorporated by reference herein in its entirety.

### BACKGROUND

### 1. Technical Field

The present disclosure relates to an electrode and a manufacturing method of an electrode.

### 2. Description of Related Art

In recent years, with the rapid proliferation of electronic devices such as personal computers and mobile phones, development of batteries used as power sources therefor has advanced. Furthermore, in the automotive industry, development of batteries used for a hybrid electric vehicle (HEV), a plug-in hybrid electric vehicle (PHEV), or a battery electric vehicle (BEV) has also advanced.

As an example of this type of battery, Japanese Unexamined Patent Application

Publication No. 2024-036847 (JP 2024-036847 A) discloses a lithium ion battery including an electrode having a current collector and an electrode layer, and an electrolyte, in which the electrode layer contains a binder having a swelling degree of 120% or more with respect to the electrolyte.

During a manufacturing process of such a battery, a high peel strength between the current collector and the electrode layer is preferable. However, when the high peel strength is maintained during disassembly of the battery for recycling, the current collector and the electrode layer may fail to separate cleanly.

Therefore, in JP 2024-036847 A, a highly swellable binder having a swelling degree of 120% or more with respect to the electrolyte is used in the electrode layer. As a result, a lithium ion battery has been proposed that exhibits high peel strength during the manufacturing process of the battery and low peel strength during disassembly of the battery, and that has excellent recyclability.

### SUMMARY

However, in an actual manufacturing process of the battery, an electrolyte is injected into the electrode to impregnate the electrode with the electrolyte. Therefore, the electrode in which a highly swellable binder is used throughout the entire electrode layer exhibits a high peel strength of the electrode layer with respect to the current collector before the injection of the electrolyte. On the other hand, the peel strength of the electrode layer with respect to the current collector decreases after the injection of the electrolyte as the highly swellable binder incorporates the injected electrolyte into a crystal structure.

Therefore, for example, when the battery described in JP 2024-036847 A is mounted in an electronic device, a vehicle, or the like and used, the electrode layer is likely to be peeled off from the current collector when vibration or impact is applied to the battery. In this manner, there has been a problem in that peeling of the electrode layer from the current collector that may occur after the electrolyte is injected leads to a decrease in quality and a decrease in performance of the battery.

The present disclosure has been made to solve such a problem, and an object thereof is to provide an electrode and a manufacturing method of an electrode capable of improving the recyclability of a battery while suppressing a decrease in quality and a decrease in performance of the battery due to peeling of an electrode layer from a current collector that may occur after the injection of an electrolyte.

An electrode according to the present disclosure includes:
a current collector; and
an electrode layer provided on the current collector, in which:
the electrode layer includes
a first electrode layer that is at least a portion of an edge portion of the electrode layer, and
a second electrode layer that is a portion of the electrode layer other than the first electrode layer; and
a peel strength of the first electrode layer with respect to the current collector is lower than
a peel strength of the second electrode layer with respect to the current collector.

A manufacturing method of an electrode according to the present disclosure, in which:
the electrode includes
a current collector, and
an electrode layer provided on the current collector;
the electrode layer includes
a first electrode layer that is at least a portion of an edge portion of the electrode layer, and a second electrode layer that is a portion of the electrode layer other than the first electrode layer; and
a peel strength of the first electrode layer with respect to the current collector is lower than
a peel strength of the second electrode layer with respect to the current collector.

According to the present disclosure, it is possible to provide an electrode and a manufacturing method of an electrode capable of improving the recyclability of a battery while suppressing a decrease in quality and a decrease in performance of the battery due to peeling of an electrode layer from a current collector that may occur after the injection of an electrolyte.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating an electrode according to the present disclosure;

FIG. 2 is a diagram illustrating an example of a manufacturing method of an electrode according to the present disclosure;

FIG. 3 is a diagram illustrating another example of the manufacturing method of an electrode according to the present disclosure;

FIG. 4 is a graph illustrating a relationship between a content concentration of a binder and a peel strength; and

FIG. 5 is a graph illustrating a relationship between a width of the first electrode layer and the peel strength.

### DETAILED DESCRIPTION OF EMBODIMENTS

### Embodiment 1

Hereinafter, embodiments of the present disclosure will be described with reference to the drawings. Note that, the embodiments of the present disclosure are not limited to the following embodiments. The drawings only show a part of the entire disclosure, and many other configurations that are not shown in the drawings are actually included. Further, in order to clarify the explanation, the following description and drawings are appropriately simplified. In the following description, the same or equivalent elements are designated by the same reference numerals, and redundant description will be omitted.

In the following description, a longitudinal direction of the electrode layer 20 is defined as an X-axis direction, a width direction of the electrode layer 20 is defined as a Y-axis direction, and a thickness direction of the electrode layer 20 is defined as a Z-axis direction. These X-axis direction, Y-axis direction, and Z-axis direction are directions intersecting (in the present disclosure, orthogonal) with each other.

### Electrode

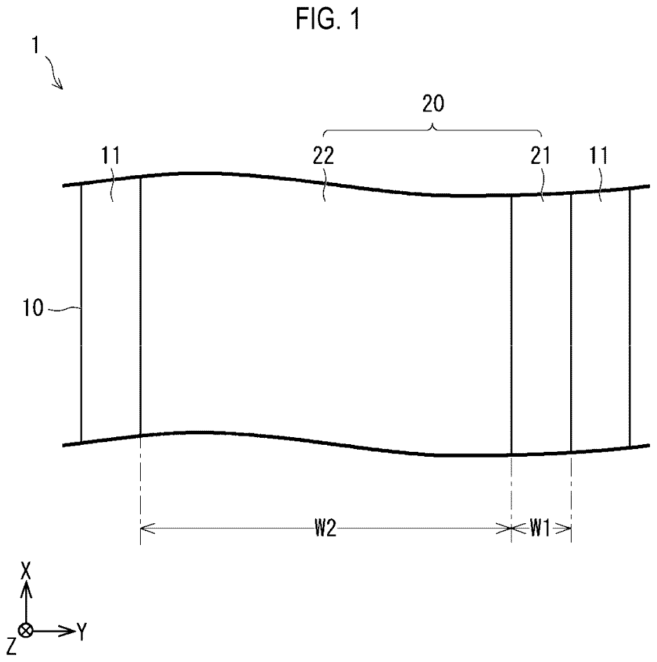

FIG. 1 is a plan view illustrating an electrode according to the present disclosure. An electrode 1 according to the present disclosure is used for a battery. The battery is typically a lithium-ion secondary battery. Examples of the application of the battery include power sources for vehicles such as a hybrid electric vehicle (HEV), a plug-in hybrid electric vehicle (PHEV), a battery electric vehicle (BEV), a gasoline automobile, and a diesel automobile. The battery may be used as a power source of a moving body other than a vehicle (for example, a train, a ship, or an airplane), or may be used as a power source of an electrical product, such as an information processing device.

The battery includes at least a positive electrode, a negative electrode, and an electrolyte in the form of an electrolytic solution. In the present disclosure, the electrode 1 will be specifically described as an electrode used for a lithium-ion secondary battery. The term “lithium-ion secondary battery” refers to a secondary battery in which lithium ions are used as charge carriers and charging and discharging are realized by movement of charges due to lithium ions between a positive electrode and a negative electrode.

The electrolyte includes, for example, a lithium salt and a solvent. Examples of the lithium salt include inorganic lithium salts such as LiPF₆, LiBF₄, LiClO₄, and LiAsF₆; and organic lithium salts such as LiCF₃SO₃, LiN(SO₂CF₃)₂, LiN(SO₂C₂F₅)₂, and LiC(SO₂CF₃)₃. Examples of the solvent include ethylene carbonate (EC), propylene carbonate (PC), butylene carbonate (BC), dimethyl carbonate (DMC), diethyl carbonate (DEC), and ethyl methyl carbonate (EMC). The solvent may be used alone or in combination of two or more types thereof.

As shown in FIG. 1, the electrode 1 includes a current collector 10 and an electrode layer 20 provided on the current collector 10. The electrode 1 has, for example, a rectangular shape in a case of being viewed from a thickness direction parallel to the Z-axis direction. The electrode 1 may be a positive electrode, a negative electrode, or both of a positive electrode and a negative electrode. The positive electrode includes a positive electrode current collector and a positive electrode layer provided on the positive electrode current collector. The negative electrode includes a negative electrode current collector and a negative electrode layer provided on the negative electrode current collector.

The current collector 10 has, for example, a rectangular shape in a case of being viewed from a thickness direction parallel to the Z-axis direction. The current collector 10 may be a positive electrode current collector or a negative electrode current collector. Examples of a material for the positive electrode current collector include SUS, aluminum, nickel, iron, titanium, and carbon. Examples of a material for the negative electrode current collector include SUS, copper, nickel, and carbon. In addition, examples of a shape of the current collector 10 include a foil shape and a mesh shape.

The current collector 10 has non-coated portions 11, where the current collector 10 is exposed without the electrode layer 20 being provided, at both end portions in the width direction parallel to the Y-axis direction. The current collector 10 may have such non-coated portion 11 only at an end portion on one side in the width direction. In addition, the current collector 10 may further have such a non-coated portion 11 at an end portion on one end side or at both end portions in the longitudinal direction parallel to the X-axis direction.

The electrode layer 20 is provided along the longitudinal direction of the current collector 10, for example. The electrode layer 20 has, for example, a rectangular shape in a case of being viewed from the Z-axis direction. The electrode layer 20 includes at least an active material and a binder.

The active material may be a positive electrode active material or may be a negative electrode active material. Examples of the positive electrode active material include a lithium transition metal oxide. Specific examples of the lithium transition metal oxide include LiNiCoMnO₂ (lithium nickel cobalt manganese composite oxide), LiNiO₂ (lithium nickel oxide), LiCoO₂ (lithium cobalt oxide), and LiMn₂O₄ (lithium manganese oxide). Examples of the negative electrode active material include a carbon material. Specific examples of the carbon material include graphite and amorphous carbon.

The active material is, for example, particulate. The particles of the active material are not particularly limited, but an average particle diameter thereof may be, for example, 1 μm or more and 50 μm or less, 2 μm or more and 30 μm or less, or 3 μm or more and 10 μm or less. In the present disclosure, the average particle diameter refers to a particle diameter (D50) corresponding to a cumulative frequency of 50% by volume from a fine particle side having a small particle diameter in a volume-based particle size distribution based on a laser diffraction/light scattering method.

A proportion of the active material in the electrode layer 20 is not particularly limited, but is, for example, 40% by weight or more, and may be 60% by weight or more, or may be 80% by weight or more.

The binder is usually a polymer. Examples of binders include fluorine-based binders, styrene-butadiene-based binders, styrene-acrylic-based binders such as styrene-acrylic resin (SAR), acrylic-based binders, and urethane-based binders. The fluorine-based binder is polyvinylidene fluoride (PVDF) or the like. The styrene butadiene-based binder is styrene-butadiene rubber (SBR) or the like.

A proportion of the binder in the electrode layer 20 is not particularly limited, but is, for example, 0.1% by weight or more, and may be 0.5% by weight or more, or may be 1% by weight or more. On the other hand, the proportion of the binder is, for example, 15% by weight or less, and may be 10% by weight or less, or may be 5% by weight or less.

The electrode layer 20 may contain components other than the active material and the binder. Examples of the other components include a conductive material and a thickener. Examples of the conductive material include a carbon material. Examples of the carbon material include carbon black such as acetylene black (AB), and carbon materials such as carbon nanotubes (CNT) and carbon nanofibers (CNF). Examples of the thickener include celluloses such as carboxymethyl cellulose (CMC) and methyl cellulose (MC).

A proportion of the other components in the electrode layer 20 is not particularly limited, but is, for example, 0.5% by weight or more, and may be 1% by weight or more. On the other hand, the proportion of the other components is, for example, 20% by weight or less, and may be 10% by weight or less.

The electrode layer 20 includes a first electrode layer 21 and a second electrode layer 22. The first electrode layer 21 is at least a portion of an edge portion of the electrode layer 20. The first electrode layer 21 is, for example, sandwiched between the second electrode layer 22 and the non-coated portion 11 from both sides in the Y-axis direction. The second electrode layer 22 is a portion of the electrode layer 20 other than the first electrode layer 21. The second electrode layer 22 includes a center of the electrode layer 20 in the Y-axis direction. The second electrode layer 22 is, for example, sandwiched between the first electrode layer 21 and the non-coated portion 11 from both sides in the Y-axis direction.

In the electrode 1 according to the present disclosure, the first electrode layer 21 and the second electrode layer 22 have different peel strengths with respect to the current collector 10. Specifically, the peel strength of the first electrode layer 21 with respect to the current collector 10 is lower than the peel strength of the second electrode layer 22 with respect to the current collector 10.

In such an electrode 1, the peel strength of the second electrode layer 22 with respect to the current collector 10 is high. As a result, the electrode layer 20 is unlikely to be peeled off from the current collector 10 before the injection of the electrolyte performed in the battery manufacturing process using the electrode 1, and the electrode layer 20 remains unlikely to be peeled off from the current collector 10 even after the injection of the electrolyte. Therefore, in the battery including the electrode 1, the decrease in quality and the decrease in performance of the battery due to the peeling of the electrode layer 20 from the current collector 10 that may occur after the injection of the electrolyte are suppressed.

In addition, in such an electrode 1, the first electrode layer 21 has a low peel strength with respect to the current collector 10, so that during disassembly for recycling the battery including the electrode 1, the electrode layer 20 is likely to be peeled off from the current collector 10 starting from the first electrode layer 21. Therefore, the recyclability of the battery including the electrode 1 is improved.

As described above, the electrode 1 according to the present disclosure can improve the recyclability of the battery while suppressing the decrease in quality and the decrease in performance of the battery due to the peeling of the electrode layer 20 from the current collector 10 that may occur after the injection of the electrolyte.

Since such an effect can be reliably obtained, the peel strength of the first electrode layer 21 with respect to the current collector 10 is, for example, preferably 0.03 N/cm or more and less than 0.08 N/cm. In the present disclosure, the “peel strength” refers to a 90-degree peel strength measured in accordance with JIS K 6854-1:1999.

From the viewpoint of improving the recyclability of the battery, the peel strength of the first electrode layer 21 with respect to the current collector 10 is preferably low within the above-described range. On the other hand, from the viewpoint of suppressing the decrease in quality and the decrease in performance of the battery due to the peeling of the electrode layer 20 from the current collector 10 that may occur after the injection of the electrolyte, the peel strength of the first electrode layer 21 with respect to the current collector 10 is preferably high within the above-described range. When the peel strength of the first electrode layer 21 with respect to the current collector 10 is 0.03 N/cm or more and less than 0.08 N/cm, the peel strength of the second electrode layer 22 with respect to the current collector 10 is 0.08 N/cm or more.

In the electrode 1 according to the present disclosure, the first electrode layer 21 and the second electrode layer 22 are disposed to be adjacent to each other along the Y-axis direction. It is preferable that the first electrode layer 21 is provided along the end portion on one side of the electrode layer 20 in the Y-axis direction. As a result, since it is possible to form the first electrode layer 21 and the second electrode layer 22 while the current collector 10 is transported, the productivity of the electrode 1 can be improved.

The first electrode layer 21 has a width W1 that is a length in the Y-axis direction. The width W1 is a distance between the end portion on one side of the first electrode layer 21 in the Y-axis direction and the end portion on one side of the second electrode layer 22 in the Y-axis direction. The width W1 is preferably 10 mm or more and 50 mm or less. As a result, a balance between the effect of suppressing the decrease in quality and the decrease in performance of the battery due to the peeling of the electrode layer 20 from the current collector 10 that may occur after the injection of the electrolyte and the effect of improving the recyclability of the battery can be improved.

From the viewpoint of improving the recyclability of the battery, the width W1 is preferably long within the above-described range. On the other hand, from the viewpoint of suppressing the decrease in quality and the decrease in performance of the battery due to the peeling of the electrode layer 20 from the current collector 10 that may occur after the injection of the electrolyte, the width W1 is preferably short within the above-described range.

The second electrode layer 22 has a width W2 that is a length in the Y-axis direction. The width W2 is a distance between the end portion on the other side of the first electrode layer 21 in the Y-axis direction and the end portion on the other side of the second electrode layer 22 in the Y-axis direction. The width W2 is preferably 50 mm or more and 1,000 mm or less. From the viewpoint of improving the recyclability of the battery, the width W2 is preferably short. On the other hand, from the viewpoint of suppressing the decrease in quality and the decrease in performance of the battery due to the peeling of the electrode layer 20 from the current collector 10 that may occur after the injection of the electrolyte, the width W2 is preferably long.

A ratio (W1/(W1+W2)) of the width W1 to a width (W1+W2) of the electrode layer 20 that is a length in the Y-axis direction is, for example, 0.1 or more and 0.5 or less, and may be 0.15 or more and 0.35 or less or 0.3 or more and 0.45 or less. When W1/(W1+W2) is within the above range, the effect of improving the recyclability of the battery can be enhanced.

### Manufacturing Method of Electrode

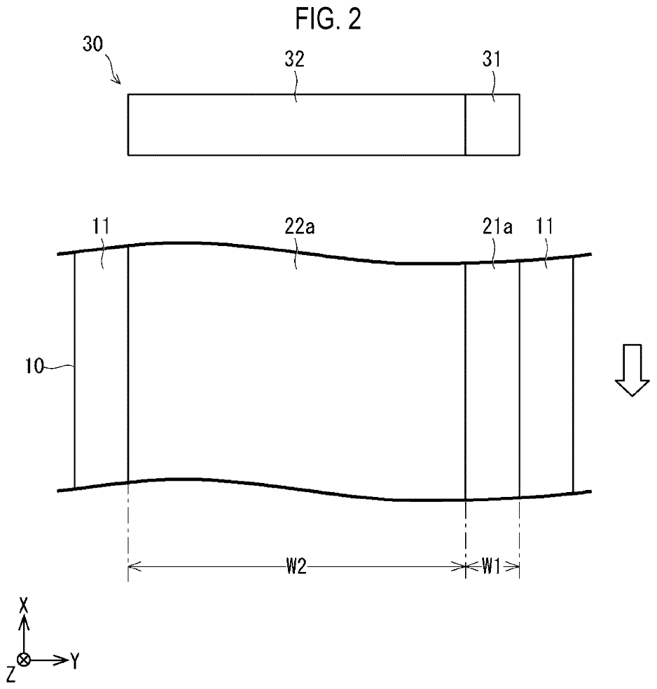

An example of the manufacturing method of an electrode according to the present disclosure will be described with reference to FIG. 2. FIG. 2 is a diagram illustrating an example of the manufacturing method of an electrode according to the present disclosure. As shown in FIG. 2, an example of the manufacturing method of the electrode 1 includes a coating process of forming the first electrode layer 21 and the second electrode layer 22 on the current collector 10 by coating the current collector 10 with two types of pastes 21a and 22a including binders different from each other.

Here, the binder included in the first electrode layer 21 is defined as a first binder, and the binder included in the second electrode layer 22 is defined as a second binder. Binders different from each other are used as the first binder and the second binder such that the peel strength of the first electrode layer 21 with respect to the current collector 10 is lower than the peel strength of the second electrode layer 22 with respect to the current collector 10.

The first binder is a binder capable of making the peel strength of the first electrode layer 21 with respect to the current collector 10 lower than the peel strength of the second electrode layer 22 with respect to the current collector 10. The second binder is a binder capable of making the peel strength of the second electrode layer 22 with respect to the current collector 10 higher than the peel strength of the first electrode layer 21 with respect to the current collector 10. Examples of a combination of the first binder and the second binder include a case where SBR is used as the first binder and a case where SAR is used as the second binder.

The paste 21a is a material for forming the first electrode layer 21. The paste 21a includes an active material, the first binder, an appropriate solvent, and other components as necessary. The paste 21a can be prepared by dispersing or dissolving the active material, the first binder, and other components as necessary in the solvent. The first electrode layer 21 can be formed by coating the current collector 10 with the paste 21a prepared in this way and drying the coating.

The paste 22a is a material for forming the second electrode layer 22. The paste 22a includes an active material, the second binder, an appropriate solvent, and other components as necessary. The paste 22a can be prepared by dispersing or dissolving the active material, the second binder, and other components as necessary in the solvent. The second electrode layer 22 can be formed by coating the current collector 10 with the paste 22a prepared in this way and drying the coating.

The pastes 21a, 22a can be prepared using, for example, an appropriate mixing device such as a ball mill, a roll mill, a planetary mixer, a disper, or a kneader. In addition, the pastes 21a, 22a can be dried using an appropriate drying device such as a hot air drying device, an infrared drying device, or a laser irradiation device.

The pastes 21a, 22a are coated on, for example, a portion of the current collector 10 other than the non-coated portion 11. As an example, the pastes 21a, 22a can be coated using a die coater 30 including a die head 31 that coats the current collector 10 with the paste 21a and a die head 32 that coats the current collector 10 with the paste 22a.

The die coater 30 can coat the current collector 10 transported in the longitudinal direction with the pastes 21a, 22a. In FIG. 2, an outline arrow indicates a transport direction of the current collector 10. The die heads 31, 32 are disposed to be arranged along a direction orthogonal to the transport direction of the current collector 10, for example. Each of the die heads 31, 32 has a slit extending in a direction orthogonal to the transport direction of the current collector 10. Each of the die heads 31, 32 coats the pastes 21a, 22a through a slit with a coating width corresponding to a length of the slit. By using such a die coater 30, the pastes 21a, 22a can be coated at the same time on the current collector 10 transported along the transport direction to be adjacent to each other.

The electrode layer 20 is formed on the current collector 10 by drying the pastes 21a, 22a respectively coated on the current collector 10 using the die coater 30. Specifically, the first electrode layer 21 is formed by drying the paste 21a coated on the current collector 10, and the second electrode layer 22 is formed by drying the paste 22a coated on the current collector 10. As a result, an electrode 1 in which the electrode layer 20 including the first electrode layer 21 having a low peel strength with the current collector 10 and the second electrode layer 22 having a high peel strength with the current collector 10 is formed on the current collector 10 can be obtained.

Further, in the coating process, it is preferable to adjust the content concentration of each binder such that the peel strength of the first electrode layer 21 with respect to the current collector 10 is 0.03 N/cm or more and less than 0.08 N/cm, and the peel strength of the second electrode layer 22 with respect to the current collector 10 is 0.08 N/cm or more. In addition, in the coating process, it is preferable to adjust the coating width of the paste 21a such that the width W1 of the first electrode layer 21 is 10 mm or more and 50 mm or less. In addition, in the coating process, it is preferable to adjust the coating positions of the pastes 21a, 22a such that the first electrode layer 21 is formed along an end portion on one side of the electrode layer 20 in the Y-axis direction.

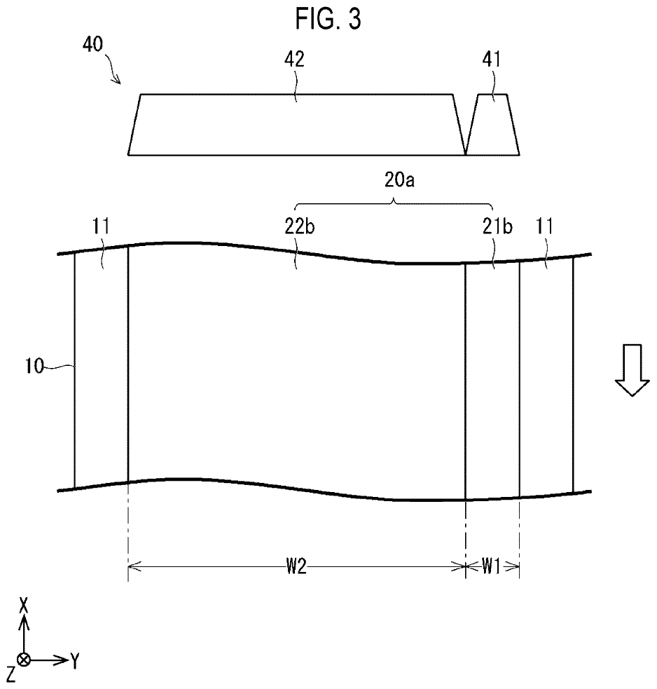

Next, another example of the manufacturing method of an electrode according to the present disclosure will be described with reference to FIG. 3. FIG. 3 is a diagram illustrating another example of the manufacturing method of an electrode according to the present disclosure. As shown in FIG. 3, another example of the manufacturing method of the electrode 1 includes a drying process of drying a paste 20a on the current collector 10 such that a migration index of the binder in the first electrode layer 21 is higher than that in the second electrode layer 22, to form the first electrode layer 21 and the second electrode layer 22 on the current collector 10.

The paste 20a is a material for forming the electrode layer 20 (the first electrode layer 21 and the second electrode layer 22). The paste 20a includes an active material, a binder, an appropriate solvent, and other components as necessary. The paste 20a can be prepared by dispersing or dissolving the active material, the binder, and other components as necessary in the solvent. The paste 20a prepared in this way is coated on, for example, a portion of the current collector 10 other than the non-coated portion 11.

The paste 20a can be prepared using an appropriate mixing device as described above. In addition, the paste 20a can be coated using an appropriate coating device such as a die coater, a comma coater, a knife coater, and a gravure coater.

Here, during the drying of the paste 20a, a phenomenon called migration, in which the binder moves to the surface side together with the solvent, may occur as the solvent evaporates from the surface of the paste 20a. When the migration occurs, the binder segregates to the surface side of the electrode layer 20, so that the peel strength with the current collector 10 may decrease.

The migration index is an index indicating a degree of segregation of the binder.

A migration index of the binder in the first electrode layer 21 is denoted by K1. For example, the electrode layer 20 may be divided into two equal parts in the Z-axis direction. In this case, the migration index K1 is a ratio (K1=B2/B1) of a content concentration B2 of the binder on the surface side of the first electrode layer 21 to a content concentration B1 of the binder on the current collector 10 side of the first electrode layer 21. In addition, when the migration index of the binder is denoted by K2, the migration index K2 is, for example, a ratio (K2=B4/B3) of a content concentration B4 of the binder to a content concentration B3 of the binder when the electrode layer 20 is divided into two equal parts in the Z-axis direction. Here, K2 is a migration index of the binder in the second electrode layer 22. Here, the content concentration B3 of the binder is a content concentration of the binder on the current collector 10 side of the second electrode layer 22. The content concentration B4 of the binder is a content concentration of the binder on the surface side of the second electrode layer 22.

In a case of drying the paste 20a on the current collector 10, the paste 20a is dried such that the migration index of the binder in the first electrode layer 21 is higher than that in the second electrode layer 22. As a result, the first electrode layer 21 has the binder distributed more on the surface side of the electrode layer 20 than in the second electrode layer 22. As a result, the peel strength of the first electrode layer 21 with respect to the current collector 10 is lower than that of the second electrode layer 22.

During drying, the migration of the binder is promoted as the drying speed is high and is suppressed as the drying speed is low. Therefore, in the drying process, a portion 21b of the paste 20a coated on the current collector 10 that becomes the first electrode layer 21 by drying, and a portion 22b of the paste 20a coated on the current collector 10 that becomes the second electrode layer 22 by drying, are dried at different drying speeds from each other.

Specifically, the drying speed for drying the portion 21b is set to be higher than the drying speed for drying the portion 22b. When the drying speed for drying the portion 21b is set to be higher than the drying speed for drying the portion 22b, the migration of the binder is promoted in the first electrode layer 21 more than in the second electrode layer 22, and the migration index of the binder is higher in the first electrode layer 21 than that in the second electrode layer 22.

As an example, the paste 20a can be dried using a laser irradiation device 40 including a laser head 41 that irradiates the surface of the portion 21b with a laser and a laser head 42 that irradiates the surface of the portion 22b with a laser.

The laser irradiation device 40 can dry the paste 20a on the current collector 10 transported in the longitudinal direction. In FIG. 3, an outline arrow indicates a transport direction of the current collector 10. The laser head 42 is disposed to be arranged along a direction orthogonal to the transport direction of the current collector 10, for example. Each of the laser heads 41, 42 emits a laser oscillated by a laser oscillator and irradiates the laser through an optical lens. An irradiation range of the laser emitted from each of the laser heads 41, 42 extends in a direction orthogonal to the transport direction of the current collector 10. By using such a laser irradiation device 40, the portions 21b, 22b on the current collector 10 transported along the transport direction can be dried at different drying speeds at the same time.

The drying speed can be adjusted by setting the energy density (W/cm²) of the laser. The drying speed increases as the energy density of the laser increases, since the drying temperature increases. On the other hand, the drying speed decreases as the energy density of the laser decreases, since the drying temperature decreases.

Therefore, in the drying process, the energy density of the laser emitted from the laser head 41 to the portion 21b is set to be higher than the energy density of the laser emitted from the laser head 42 to the portion 22b. As a result, the migration index of the binder in the first electrode layer 21 formed by drying the portion 21b can be set to be higher than the migration index of the binder in the second electrode layer 22 formed by drying the portion 22b. As a result, an electrode 1 in which the electrode layer 20 including the first electrode layer 21 having a low peel strength with the current collector 10 and the second electrode layer 22 having a high peel strength with the current collector 10 is formed on the current collector 10 can be obtained.

The energy density of each laser is set within a range that allows the solvent to be evaporated without causing degradation of the solid content included in the paste 20a, while obtaining a desired peel strength. From such a viewpoint, the energy density of the laser emitted to the portion 21 b may be, for example, more than 50 W/cm² and 100 W/cm² or less. The energy density of the laser emitted to the portion 22b may be, for example, 1 W/cm² or more and 50 W/cm² or less.

Further, in the drying process, it is preferable to adjust the energy density of each laser such that the peel strength of the first electrode layer 21 with respect to the current collector 10 is 0.03 N/cm or more and less than 0.08 N/cm, and the peel strength of the second electrode layer 22 with respect to the current collector 10 is 0.08 N/cm or more. In addition, in the drying process, it is preferable to adjust the width of the irradiation range of the laser such that the width W1 of the first electrode layer 21 is 10 mm or more and 50 mm or less. In addition, in the drying process, it is preferable to adjust the irradiation positions of the lasers such that the first electrode layer 21 is formed along an end portion on one side of the electrode layer 20 in the Y-axis direction.

### Study on Preferable Range of Peel Strength of First Electrode Layer

In order to study the preferable range of the peel strength of the first electrode layer 21 with respect to the current collector 10, six test electrodes in which the content concentration of the binder in the electrode layer formed on the current collector was changed in various ways were produced, and then the peel strength was measured and the adhesion test was performed.

The test electrodes were produced as follows.
First, the following materials were prepared in order to produce the test electrodes.
Active material: artificial graphite
Binder: SBR
Thickener: CMC

### Conductive Material: Cnt

Solvent: water

### Current Collector: Copper Foil

Next, the active material, binder, thickener, conductive material were mixed with a solvent in a mass ratio of 95:3.9:1:0.1 using a mixing device to prepare a paste. Next, the prepared paste was coated on one surface of the current collector using a coating device. Thereafter, the paste coated on the current collector was dried with a drying device to form an electrode layer on the current collector. As a result, a test electrode in which the electrode layer was formed on the current collector was obtained.

Further, for each of the produced test electrodes, the peel strength of the electrode layer with respect to the current collector was measured according to the 90-degree peel test specified in JIS K6854-1:1999. Specifically, after fixing the current collector side of the test electrode to a test table, the electrode layer was pulled upward in a vertical direction from the current collector at a speed of 25 mm/min to 100 mm/min, and the tensile force (N) when the electrode layer was peeled off from the current collector was measured with an autograph. The peel strength was calculated by arithmetically averaging the tensile forces at the above-mentioned pulling speeds.

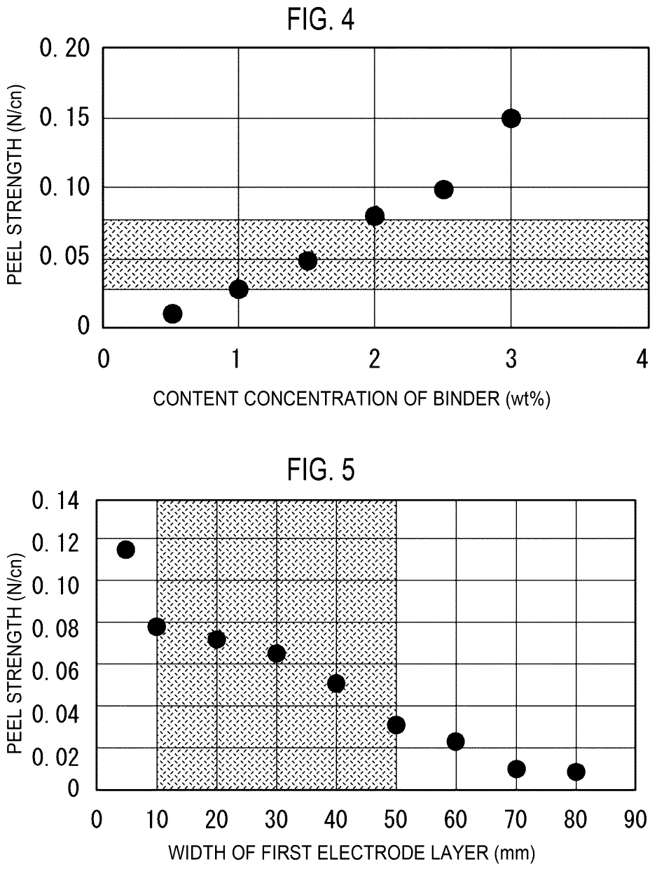

FIG. 4 is a graph illustrating a relationship between the content concentration of the binder and the peel strength. The graph illustrated in FIG. 4 shows the result of measuring the peel strength of the electrode layer with respect to the current collector for each of the six produced test electrodes. The horizontal axis of the graph illustrated in FIG. 4 indicates the content concentration (wt %) of the binder in the electrode layer formed on the current collector. The vertical axis of the graph illustrated in FIG. 4 indicates the peel strength (N/cm) of the electrode layer with respect to the current collector.

As can be seen from the graph illustrated in FIG. 4, the peel strength of the electrode layer with respect to the current collector can be adjusted by the content concentration of the binder in the electrode layer. As the content concentration of the binder increases, the peel strength of the electrode layer with respect to the current collector becomes higher, and the electrode layer is unlikely to be peeled off from the current collector. On the contrary, as the content concentration of the binder decreases, the peel strength of the electrode layer with respect to the current collector becomes lower, and the electrode layer is likely to be peeled off from the current collector.

In addition, the adhesion test was performed on each of the six produced test electrodes. The adhesion test was performed by visually checking whether the electrode layer peeled off from the current collector when the test electrode was wound around a predetermined cylindrical member, with one corner portion of the rectangular test electrode as a start point for winding.

As a result, in one test electrode in which the peel strength of the electrode layer with respect to the current collector was less than 0.03 N/cm, the electrode layer peeled off from the current collector during the production (during the transport between the processes), so that sufficient quality was not obtained. In the remaining five test electrodes in which the peel strength of the electrode layer with respect to the current collector was 0.03 N/cm or more, the electrode layer did not peel off from the current collector during the production. Among these, in three test electrodes in which the peel strength of the electrode layer with respect to the current collector was 0.08 N/cm or more, the electrode layer did not peel off from the current collector as a result of the adhesion test. In two test electrodes in which the peel strength of the electrode layer with respect to the current collector was 0.03 N/cm or more and less than 0.08 N/cm, the electrode layer peeled off from the current collector with the corner portion of the electrode layer as a starting point as a result of the adhesion test.

From the result of such an adhesion test, the preferable range of the peel strength of the first electrode layer 21 with respect to the current collector was set to 0.03 N/cm or more and less than 0.08 N/cm.

### Study on Preferable Range of Width of First Electrode Layer

In order to study the preferable range of the width W1, nine test electrodes in which the width W1 of the first electrode layer 21 in the electrode layer 20 formed on the current collector 10 was changed in various ways were produced, and then the peel strength was measured and the adhesion test was performed.

The test electrodes were produced as follows.
First, the following materials were prepared in order to produce the test electrodes.
Active material: artificial graphite
First binder: SBR
Second binder: SAR
Thickener: CMC
Conductive Material: Cnt
Solvent: water

### Current Collector: Copper Foil

Next, the active material, first binder, thickener, conductive material were mixed with a solvent in a mass ratio of 95:3.9:1:0.1 using a mixing device to prepare a paste 21a. In addition, the active material, second binder, thickener, conductive material were mixed with a solvent in a mass ratio of 95:3.9:1:0.1 using a mixing device to prepare a paste 22a.

Next, the prepared pastes 21a, 22a were coated at the same time on one surface of the current collector 10 using the die coater 30. During the coating, the coating width of the paste 21 a was adjusted such that the width W1 of the first electrode layer 21 was 5 mm, 10 mm, 20 mm, 30 mm, 40 mm, 50 mm, 60 mm, 70 mm, or 80 mm. In addition, during the coating, the coating width of the paste 22a was adjusted according to the coating width of the paste 21 a such that the width of the electrode layer 20 was 300 mm in all the test electrodes.

Thereafter, the pastes 21a, 22a coated on the current collector 10 were dried with a drying device to form the first electrode layer 21 and the second electrode layer 22 on the current collector 10. As a result, a test electrode in which the electrode layer 20 including the first electrode layer 21 and the second electrode layer 22 was formed on the current collector 10 was obtained.

Further, the peel strength was obtained for each of the produced test electrodes in the same procedure as in the “Study on Preferable Range of Peel Strength of First Electrode Layer”.

FIG. 5 is a graph illustrating a relationship between a width of the first electrode layer 21 and the peel strength. The graph illustrated in FIG. 5 shows the result of measuring the peel strength of the electrode layer 20 with respect to the current collector 10 for each of the nine produced test electrodes. The horizontal axis of the graph illustrated in FIG. 5 indicates the width (mm) of the first electrode layer 21 in the electrode layer 20 formed on the current collector 10. The vertical axis of the graph illustrated in FIG. 5 indicates the peel strength (N/cm) of the electrode layer 20 with respect to the current collector 10.

As can be seen from the graph illustrated in FIG. 5, the peel strength of the electrode layer 20 with respect to the current collector 10 can be adjusted by the width W1. As the width W1 decreases, the peel strength of the electrode layer 20 with respect to the current collector 10 becomes higher, and the electrode layer 20 is unlikely to be peeled off from the current collector 10. On the contrary, as the width W1 increases, the peel strength of the electrode layer 20 with respect to the current collector 10 becomes lower, and the electrode layer 20 is likely to be peeled off from the current collector 10.

In addition, the adhesion test was performed on each of the nine produced test electrodes in the same procedure as in the “Study on Preferable Range of Peel Strength of First Electrode Layer”.

As a result, in the test electrode in which the width W1 was less than 10 mm, both the first electrode layer 21 and the second electrode layer 22 of the electrode layer 20 did not peel off from the current collector 10. In the three test electrodes in which the width W1 was more than 50 mm, both the first electrode layer 21 and the second electrode layer 22 of the electrode layer 20 peeled off from the current collector 10. Then, in the remaining five test electrodes in which the width W1 was 10 mm or more and 50 mm or less, the first electrode layer 21 peeled off from the current collector 10, while the second electrode layer 22 did not peel off from the current collector 10.

Therefore, it is considered that the five test electrodes in which the width W1 was 10 mm or more and 50 mm or less can improve the recyclability of the battery more than the test electrode in which the width W1 was less than 10 mm. In addition, it is considered that the five test electrodes can suppress the decrease in quality and the decrease in performance of the battery due to the peeling of the electrode layer 20 from the current collector 10 that may occur after the injection of the electrolyte, compared to the three test electrodes in which the width W1 was more than 50 mm. Here, in the five test electrodes, the width W1 is 10 mm or more and 50 mm or less. From the result of such an adhesion test, the preferable range of the width W1 was set to 10 mm or more and 50 mm or less.

The present disclosure is not limited to the embodiment, and can be appropriately modified without departing from the spirit. For example, in the above-described embodiment, the example has been described in which the first electrode layer 21 is formed along only an end portion on one side of the electrode layer 20 in the Y-axis direction, but the present disclosure is not limited thereto. When the electrode layer 20 has four end portions of end portions on both sides of the electrode layer 20 in the Y-axis direction and end portions on both sides of the electrode layer 20 in the X-axis direction, the first electrode layer 21 need only be provided along one or more end portions.

What is claimed is:

1. An electrode comprising:
a current collector; and
an electrode layer provided on the current collector, wherein:
the electrode layer includes
a first electrode layer that is at least a portion of an edge portion of the electrode layer, and
a second electrode layer that is a portion of the electrode layer other than the first electrode layer; and
a peel strength of the first electrode layer with respect to the current collector is lower than a peel strength of the second electrode layer with respect to the current collector.

2. The electrode according to claim 1, wherein the peel strength of the first electrode layer with respect to the current collector is 0.03 N/cm or more and less than 0.08 N/cm.

3. The electrode according to claim 1, wherein a length of the first electrode layer in a width direction is 10 mm or more and 50 mm or less.

4. The electrode according to claim 1, wherein the first electrode layer is provided along an end portion on one side of the electrode layer in a width direction.

5. A manufacturing method of an electrode, wherein:
the electrode includes
a current collector, and
an electrode layer provided on the current collector;
the electrode layer includes
a first electrode layer that is at least a portion of an edge portion of the electrode layer, and
a second electrode layer that is a portion of the electrode layer other than the first electrode layer; and
a peel strength of the first electrode layer with respect to the current collector is lower than a peel strength of the second electrode layer with respect to the current collector.
